(19) United States
(12) Patent Application Publication
(10) Pub. No.: US 2024/0265486 A1
(43) Pub. Date: Aug. 8, 2024

(54) BACKFACE CULLING FOR GUARD BAND CLIPPING PRIMITIVES

(71) Applicant: QUALCOMM Incorporated, San Diego, CA (US)

(72) Inventors: Tao WANG, Sunnyvale, CA (US); Ashokanand NEELAMBARAN, Bangalore (IN); Jian LIANG, San Diego, CA (US); Xiayang ZHAO, San Diego, CA (US); Lingjun CHEN, San Diego, CA (US)

(21) Appl. No.: 18/163,845

(22) Filed: Feb. 2, 2023

(51) Int. Cl. G06T 1/20; G06T 1/60; G06T 3/40; G06T 11/00

(52) U.S. Cl. CPC G06T 1/20; G06T 1/60; G06T 3/40; G06T 11/00

(57) ABSTRACT

This disclosure provides systems, devices, apparatus, and methods, including computer programs encoded on storage media, for backface culling for guard band clipping primitives. A graphics processor may identify at least one backface primitive in a set of primitives that extends beyond at least one guard band, where the at least one backface primitive is identified based on a set of fixed point coordinates. The graphics processor may cull the at least one backface primitive. The graphics processor may transmit an indication of the culled at least one backface primitive.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for backface clipping may be computationally intensive. There is a need for improved techniques pertaining to backface clipping.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for graphics processing are provided. The apparatus includes a memory; and at least one processor coupled to the memory and, based at least in part on information stored in the memory, the at least one processor is configured to identify at least one backface primitive in a set of primitives that extends beyond at least one guard band, where the at least one backface primitive is identified based on a set of fixed point coordinates; cull the at least one backface primitive; and transmit an indication of the culled at least one backface primitive.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 is a diagram illustrating example aspects of backface in accordance with one or more techniques of this disclosure.

FIG. 5 is a diagram illustrating example aspects of guard band clipping in accordance with one or more techniques of this disclosure.

FIG. 6 is a diagram illustrating example aspects of transformations performed in homogeneous space in accordance with one or more techniques of this disclosure.

FIG. 7 is a diagram illustrating example aspects of a fixed point number and a floating point number in accordance with one or more techniques of this disclosure.

FIG. 8 is a diagram illustrating an example graphics pipeline in accordance with one or more techniques of this disclosure.

FIG. 9 is a diagram illustrating an example of a first triangle associated with floating point coordinates and a second triangle associated with fixed point coordinates in accordance with one or more techniques of this disclosure.

FIG. 10 is a call flow diagram illustrating example communications between a graphics processor and a graphics processor component in accordance with one or more techniques of this disclosure.

FIG. 11 is a flowchart of an example method of graphics processing in accordance with one or more techniques of this disclosure.

FIG. 12 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

A graphics processor (e.g., a GPU or another device) may obtain a set of vertex coordinates in floating point format from a vertex shader, where the set of vertex coordinates may be associated with primitives, such as triangles. However, in order to perform rasterization, the GPU may convert the set of vertex coordinates from floating point format to fixed point format. The GPU may perform clipping (e.g., triangle guard band clipping) on the primitives such that primitives that are out of a range of a fixed point number may be represented by a fixed point coordinate in a fixed point format. Clipping may be a computationally expensive process and may include multiple calculation steps. Some GPUs may perform backface culling of primitives that are backfacing after performing clipping.

Various technologies pertaining to backface culling are described herein. In an example, an apparatus identifies at least one backface primitive in a set of primitives that extends beyond at least one guard band, where the at least one backface primitive is identified based on a set of fixed point coordinates. The apparatus culls the at least one backface primitive. The apparatus transmits an indication of the culled at least one backface primitive. Vis-à-vis identifying the at least one backface primitive and culling the at least one backface primitive, the apparatus may cull the at least one backface primitive prior to performing clipping (e.g., guard band clipping) on the set of primitives. This may reduce an amount of computations performed by the apparatus and reduce power consumed by the apparatus in comparison to an apparatus that performs backface culling after clipping, as the culled backface primitive may not undergo clipping as it is already culled (i.e., removed).

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

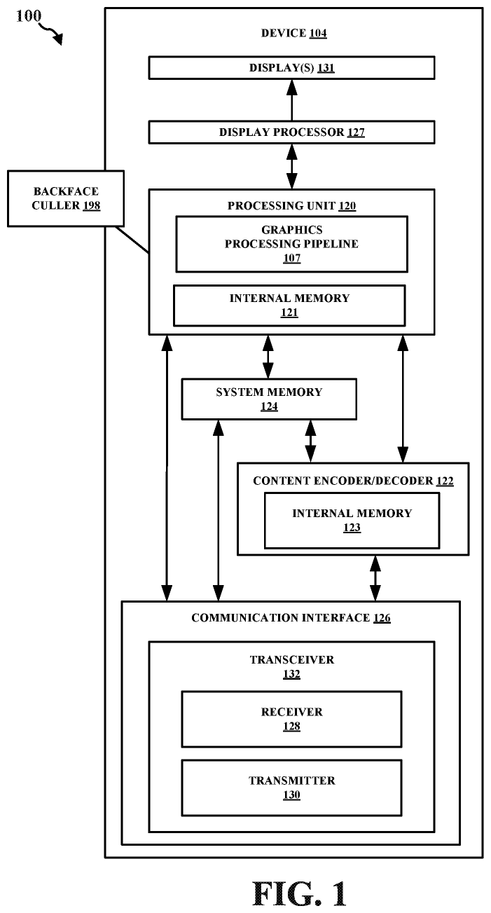

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content. The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a backface culler 198 configured to identify at least one backface primitive in a set of primitives that extends beyond at least one guard band, where the at least one backface primitive is identified based on a set of fixed point coordinates; cull the at least one backface primitive; and transmit an indication of the culled at least one backface primitive. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

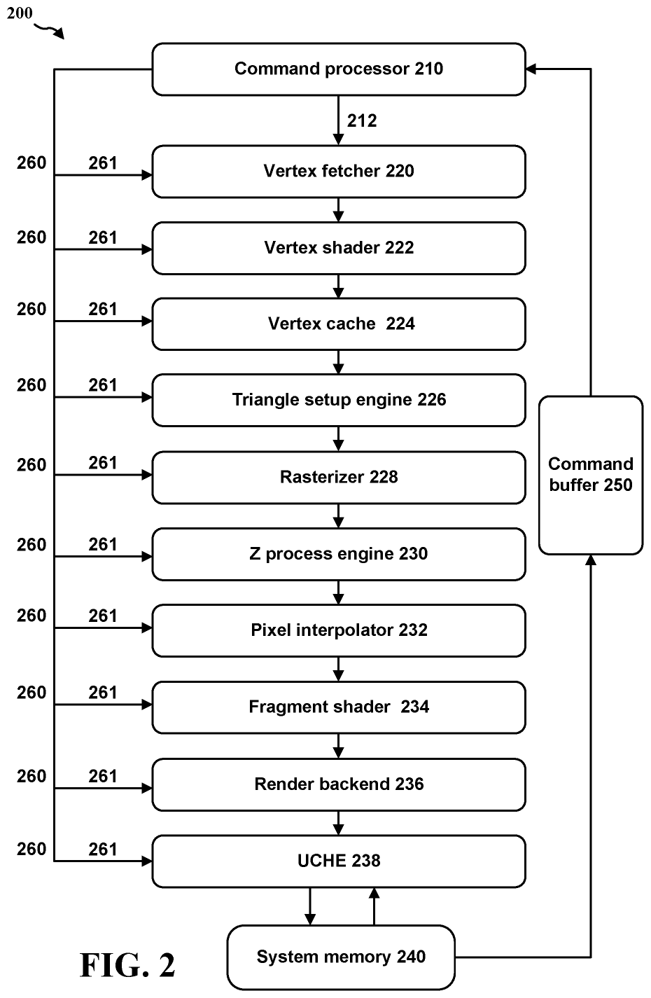

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

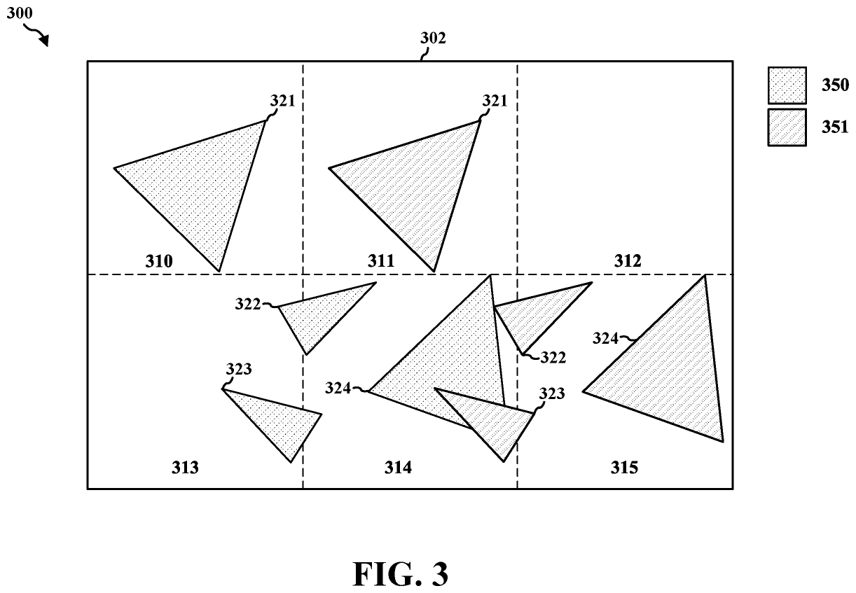

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

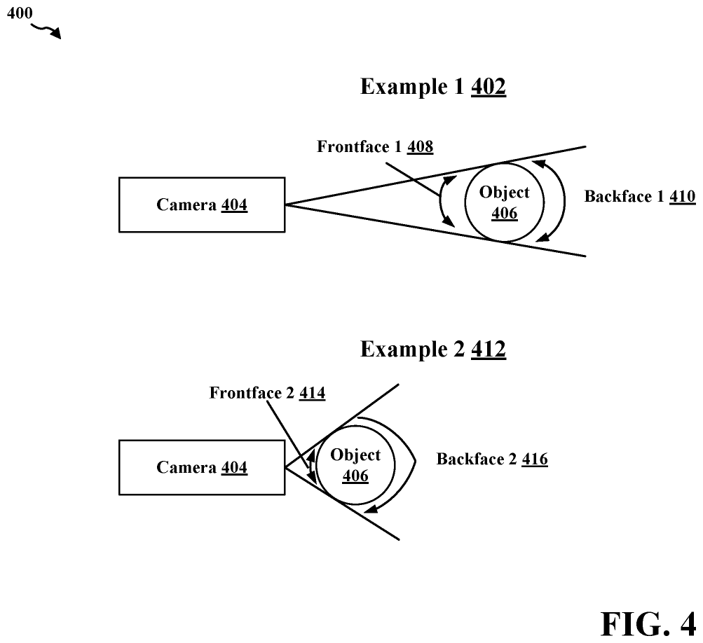

FIG. 4 is a diagram 400 illustrating example aspects of backface. A back of a solid, opaque object may be hidden from a direct line of sight from an observer. As such, when a scene is rendered on a display, the observer may not be able to see the back of the solid, opaque object. An apparatus (e.g., a GPU) may cull (i.e., remove) primitives (e.g., triangles) associated with the back of the solid, opaque object in order to reduce an amount of scene geometry that is rendered. The aforementioned culling may be referred to as “backface culling.” Reducing the amount of scene geometry that is rendered may reduce an amount of computations performed by the apparatus.

In a first example 402, a lens of a camera 404 may face an object 406. The object 406 may be solid and opaque. A portion of the object 406 that is visible to the camera 404 may be referred to as a frontface of the object 406 (referred to now as “a first frontface 408”). A portion of the object 406 that is not visible to the camera 404 may be referred to as a backface of the object 406 (referred to now as “a first backface 410”). In the first example 402, the camera 404 may be located relatively far away from the object 406 and hence the first backface 410 may be around 50% of a surface of the object 406. An apparatus may perform backface culling on primitives associated with the first backface 410 in order to reduce the amount of scene geometry rendered.

In a second example 412, the lens of the camera 404 may face the object 406 as in the first example 402. However, in the second example 412, the object 406 may be located relatively closer to the camera 404 in comparison to a location of the object 406 and the camera 404 in the first example 402. The object 406 may have a second frontface 414 and a second backface 416. As the object 406 is located closer to the lens of the camera 404 compared to the location of the object 406 and the camera 404 in the first example 402, the second backface 416 may be relatively large. For instance, the second backface 416 may be greater than 50% of the surface of the object 406. An apparatus may perform backface culling on primitives associated with the second backface 416 in order to reduce the amount of scene geometry rendered.

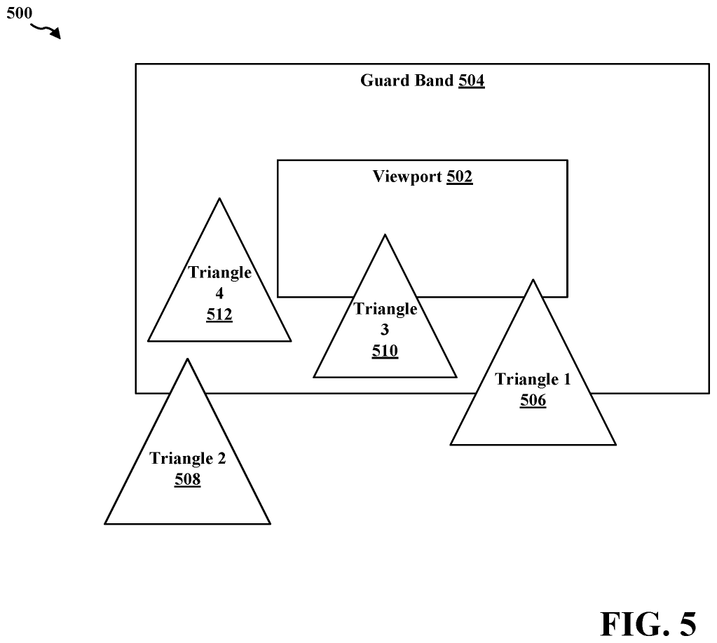

FIG. 5 is a diagram 500 illustrating example aspects of guard band clipping. Guard band clipping may refer to a technique used by an apparatus (e.g., a GPU) to reduce an amount of clipping performed. In guard band clipping, a primitive may be clipped if the primitive extends beyond a guard band, where the guard band is associated with a first region that is larger than a second region associated with a viewport and that encompasses the viewport. In an example, the first region associated with the guard band may be orders of magnitude greater than the second region associated with the viewport. In non-guard band clipping, a primitive may be clipped if the primitive extends beyond the viewport. As used herein, the term “clipping” may refer to removing a portion of a primitive (e.g., a triangle) from a rendering process. Guard band clipping may enable the apparatus to accept primitives that are partially or completely off-screen.

The diagram 500 depicts a viewport 502 and a guard band 504. In an example, the viewport 502 may be associated with a first area and the guard band 504 may be associated with a second area, where the first area is smaller than the second area. The viewport 502 may be located within the guard band 504. In an example, the viewport 502 may be associated with a resolution of 1920 pixels by 1080 pixels.

In an example, a first triangle 506 may include a first portion located in the viewport 502, a second portion located outside of the viewport 502 and within the guard band 504, and a third portion located outside of the guard band 504. In an example, the first triangle 506 may be defined by floating point coordinates (described in greater detail below). An apparatus (e.g., a GPU) may clip the second portion and the third portion as the first triangle 506 extends beyond the guard band 504. Alternatively, the apparatus may clip the third portion. After clipping, the first triangle 506 may be represented by fixed point coordinates (described in greater detail below).

In another example, a second triangle 508 may include a first portion that is within the guard band 504 and a second portion that is outside of the guard band 504. The apparatus may remove the second triangle 508 from a rendering process as the second triangle 508 does not intersect the viewport 502. When removed from the rendering process, the second triangle 508 may not have to undergo clipping and hence computational costs may be reduced. Alternatively, the apparatus may clip the second portion of the second triangle 508.

In yet another example, a third triangle 510 may include a first portion that is within the viewport 502 and a second portion that is within the guard band 504. As the third triangle 510 does not extend beyond the guard band 504, the apparatus may accept the third triangle 510 and the apparatus may avoid performing clipping on the third triangle 510.

In a further example, a fourth triangle 512 may be within the guard band 504 and the fourth triangle 512 may not intersect the viewport 502. The apparatus may remove the fourth triangle 512 from a rendering process as the fourth triangle 512 does not intersect the viewport 502. When removed from the rendering process, the fourth triangle 512 may not have to undergo clipping and hence computational costs may be reduced.

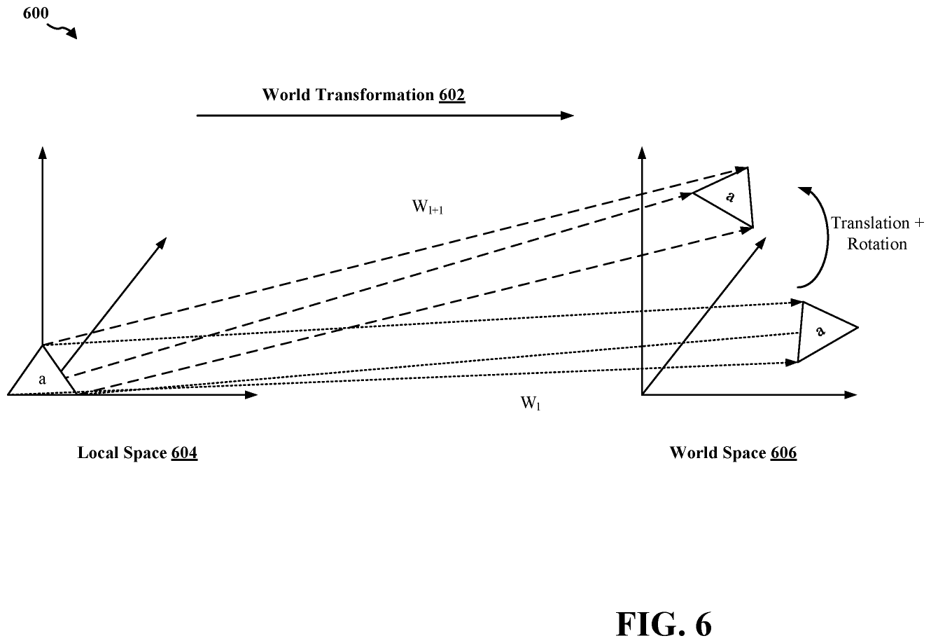

FIG. 6 is a diagram 600 illustrating example aspects of transformations performed in homogeneous space. A homogenous coordinate system may be created by raising a dimension of a Cartesian coordinate system used as a base. For instance, the Cartesian coordinate system may have n dimensions (Dim(n)) and the homogeneous coordinate system may have n+1 dimensions (Dim(n+1)), where n is 3.

In an example with respect to graphics processing, a homogenous 4-dimensional space of (X, Y, Z, W) may be created for geometry data. Stated differently, a homogenous 4-dimensional coordinate system may be created. In an example, the homogenous 4-dimensional coordinate system (XYZW) may be created from a Cartesian coordinate system (XYZ) by adding W to the Cartesian coordinate system. In an example, W may be 1.0 to facilitate conversion from the Cartesian coordinate system (XYZ) to the homogenous 4-dimensional coordinate system. Converting from the homogenous 4-dimensional coordinate system to the Cartesian coordinate system may be accomplished through a projective transformation which may include a division operation.

When geometry data is in a homogenous 4-dimensional coordinate system, graphics transformations may be represented as 4×4 matrix multiplications. The graphics transformations may include rotation, translation, and projection. Equations (I), (II), (III), and (IV) below respectively describe a reflection of a y-axis (M₁), a scaling of x, y, and z axes (M₂), a translation of an origin (M₃), and a viewport matrix (M_{viewport}).

$${M}_{1} = [ \begin{matrix}1 & 0 & 0 & 0 \\ 0 & - 1 & 0 & 0 \\ 0 & 0 & 1 & 0 \\ 0 & 0 & 0 & 1\end{matrix} ] \qquad ( I )$$

$${M}_{2} = [ \begin{matrix}w / 2 & 0 & 0 & 0 \\ 0 & h / 2 & 0 & 0 \\ 0 & 0 & max Z - min Z & 0 \\ 0 & 0 & 0 & 1\end{matrix} ] \qquad ( II )$$

$${M}_{3} = [ \begin{matrix}1 & 0 & 0 & min X + w / 2 \\ 0 & 1 & 0 & min Y + h / 2 \\ 0 & 0 & 1 & min Z \\ 0 & 0 & 0 & 1\end{matrix} ] \qquad ( III )$$

$${M}_{viewport} = {M}_{3} {M}_{2} {M}_{1} = [ \begin{matrix}w / 2 & 0 & 0 & min X + w / 2 \\ 0 & - h / 2 & 0 & min Y + h / 2 \\ 0 & 0 & max Z - min Z & min Z \\ 0 & 0 & 0 & 1\end{matrix} ] \qquad ( IV )$$

When geometry data is in the homogenous 4-dimensional coordinate system, geometry computations and color computations may be performed with dot product operations (MUL/ADD) and divide operations. Such computations may be referred to as a “geometry transformation” or a “vertex transform.” In general, an apparatus may perform a model transform, a view transform, and a projection transform as part of a rendering process for the geometry data. Vertex shading may be referred to as a programmed version of a transformation.

In an example, an apparatus (e.g., a GPU) may perform a world transformation 602 which transforms a triangle (i.e., a primitive) represented in homogenous 4-dimensional coordinates from a local space 604 to a world space 606.

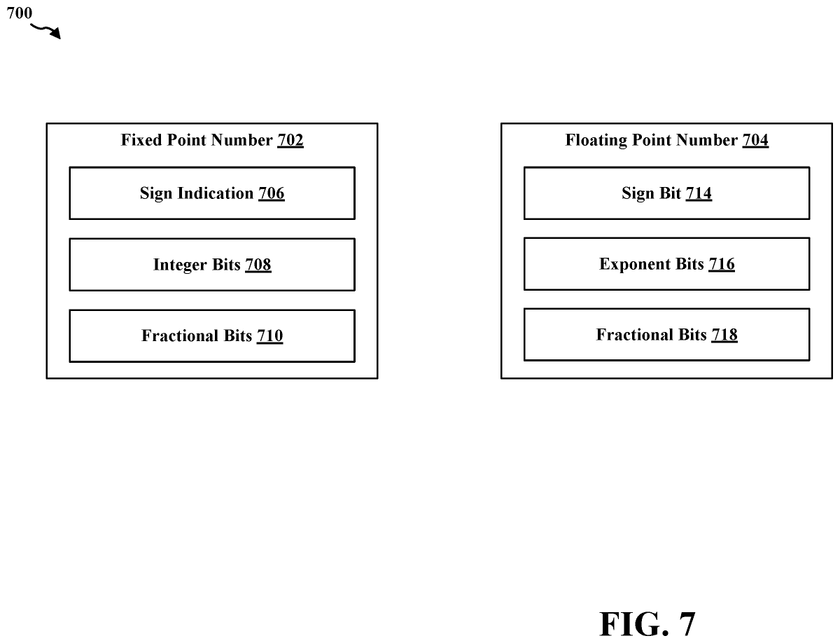

FIG. 7 is a diagram 700 illustrating example aspects of a fixed point number 702 and a floating point number 704. The fixed point number 702 and/or the floating point number 704 may be utilized as a coordinate for a primitive (e.g., a triangle) that is associated with a display process. In an example, a triangle may be represented by three vertices, where each vertex may be represented as two fixed point numbers (e.g., fixedpoint_x, fixedpoint y) in two-dimensional (2D) space. For instance, the two fixed point numbers (e.g., fixedpoint_x, fixedpoint_y) may represent a vertex location in the 2D space, for example, in screen space. In another example, a triangle may be represented by three vertices, where each vertex is represented by two floating point numbers (e.g., floatingpoint_x, floatingpoint_y). For instance, the two floating point numbers (e.g., floatingpoint_x, floatingpoint_y) may represent a vertex location in 2D space, for example, in screen space.

The fixed point number 702 may be associated with a fixed location of a decimal point. The fixed point number 702 may include a sign bit 706, integer bits 708, and fractional bits 710. If a fixed point number 702 includes the sign bit 706, the fixed point number 702 may represent a positive number, a negative number, or zero. If a fixed point number 702 does not include the sign bit 706, the fixed point number 702 may represent a positive number or zero, and may not represent a negative number. The integer bits 708 may represent an integer part of the fixed point number 702 and the fractional bits 710 may represent a fractional part of the fixed point number 702. In the fixed point number 702, a number of the integer bits 708 and a number of the fractional bits 710 may be fixed. In an example, the integer bits 708 may include 15 bits and the fractional bits 710 may include 8 bits. In the example, the fixed point number 702 may be referred to as being in “sign. 15.8 fixed point format.” In the example, the sign. 15.8 fixed point format may represent data in a range of [−32768, 32767.99609375]. The fixed point number 702 may be used to represent a coordinate of a primitive on a screen.

The floating point number 704 may be associated with a decimal point that is able to move (i.e., “float”). The floating point number 704 may include a sign bit 714, exponent bits 716, and fractional bits 718. The sign bit 714 may indicate whether the floating point number 704 is positive or negative. The exponent bits 716 may represent an integer portion of the floating point number 704. The fractional bits 718 may represent a fractional portion of the floating point number 704. In an example, the floating point number 704 may include 8 exponent bits representing an exponent from −127 to 127 and 23 fractional bits, and as such, the floating point number 704 may represent values in a range of +/−(2−2⁻²³)×2¹²⁷, which is approximately equal to +/−3.4028235×10³⁸. In comparison to the fixed point number 702, the floating point number 704 may offer increased range or increased precision at the same bit count.

In an example, after an apparatus (e.g., a GPU) performs vertex shading and a viewport transform, vertex coordinates may be in floating point format. For instance, a vertex coordinate in the vertex coordinates may include the floating point number 704. However, the apparatus may be configured with a rasterization process that utilizes a fixed point format. As such, the apparatus may convert the vertex coordinates from the floating point format to the fixed point format. For instance, a vertex coordinate in the converted vertex coordinates may include the fixed point number 702. In an example, the floating point format may represent data in the range of +/−3.4028235×10³⁸ and the fixed point format may represent data in the range of [−32768, 32767.99609375]. The apparatus may perform guard band clipping (discussed above) on triangles to clip parts of triangles that are out of range of a guard band such that after clipping, the remaining portions of the triangles may be represented by fixed point coordinates.

Clipping may be computationally expensive in a GPU pipeline. For instance, clipping may include multiple computation steps that may affect GPU performance and that may consume increased power when a relatively large amount of clipping operations is performed. In an example involving the GPU pipeline, the calculation order may be as follows: vertex shading (floating point coordinate), clipping, viewport transform (floating point coordinate), format conversion to convert floating point coordinates to fixed point coordinates, calculation of triangle facing (fixed point coordinate), backface culling (fixed point coordinate), rasterization (fixed point coordinate), and pixel shading.

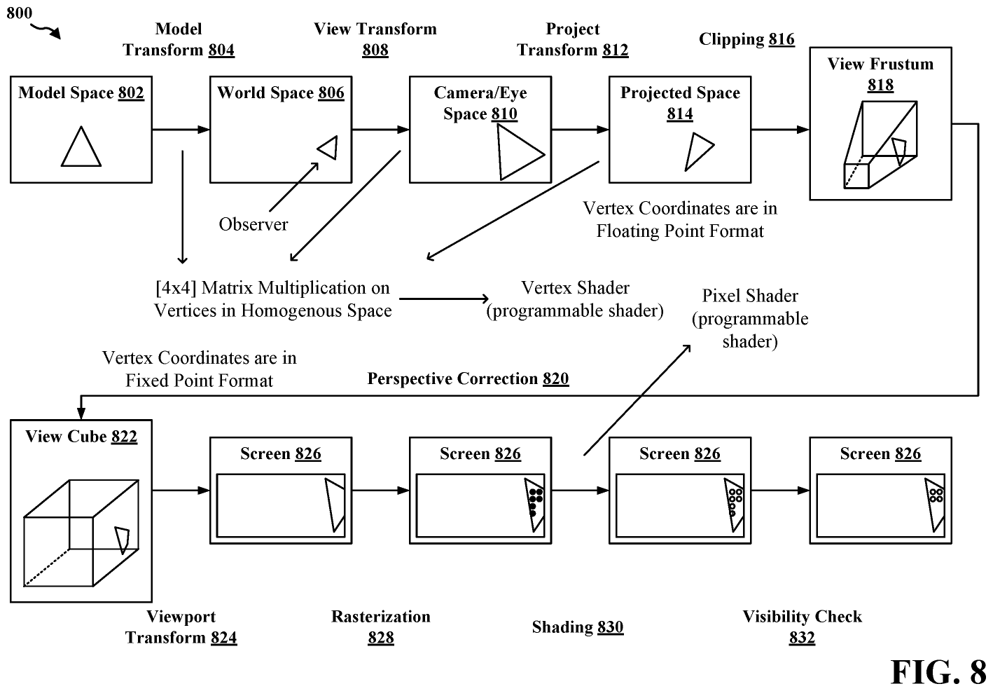

FIG. 8 is a diagram 800 illustrating an example graphics pipeline. An apparatus (e.g., a GPU) may obtain a set of coordinates associated with vertices of a triangle in a model space 802. The model space 802 may be a coordinate system local to the triangle. Stated differently, the model space 802 for the triangle may be the same regardless of a position or orientation of the triangle. The coordinate system of the model space 802 may be a 4-dimensional homogenous coordinate system (e.g., as described above).

The apparatus may perform a model transform 804 to transform the triangle from the model space 802 to a world space 806. The model transform 804 may utilize 4×4 matrix multiplication on vertices in a homogenous space. The world space 806 may be a coordinate system that is relative to locations of other triangles in a scene. Stated differently, the world space 806 for the triangle may change as a position and/or an orientation of the triangle changes relative to other triangles. The coordinate system of the world space 806 may be a 4-dimensional homogenous coordinate system (e.g., as described above).

The apparatus may perform a view transform 808 to transform the triangle from the world space 806 to a camera/eye space 810. The camera/eye space 810 may also be referred to as “a camera space,” “an eye space,” or “a view space.” The view transform 808 may utilize 4×4 matrix multiplication on vertices in the homogenous space. The camera/eye space 810 may be a coordinate system that is relative to a camera (i.e., an observer). The coordinate system of the camera/eye space 810 may be a 4-dimensional homogenous coordinate system (e.g., as described above).

The apparatus may perform a project transform 812 to transform the triangle from the camera/eye space 810 to a projected space 814. The project transform 812 may utilize 4×4 matrix multiplication on vertices in the homogenous space. Vertex coordinates of the triangle may be in floating point format in the projected space 814. Furthermore, the project transform 812 may be associated with a vertex shader.

The apparatus may perform clipping 816 on the triangle in the projected space 814 to obtain a clipped primitive in a view frustum 818 (which may also be referred to as “a viewing frustum”). In an example, after clipping, the triangle may be a quadrilateral (as depicted in the diagram 800). The clipped triangle will now be referred to as “the clipped primitive” for the sake of explanation. The view frustum 818 may refer to a region of space in a modeled world that may appear on screen. The view frustum 818 may be a field of view of a perspective virtual camera system.

The apparatus may perform perspective correction 820 on the clipped primitive in the view frustum 818 to obtain the clipped primitive in a view cube 822. The vertex coordinates may be in fixed point format after performing the perspective correction 820. The view cube 822 may be a unit cube. Computations performed with respect to the view cube 822 may be faster (i.e., less complex) compared to computations performed with respect to the view frustum 818.

The apparatus may perform a viewport transform 824 to transform the clipped primitive from the view cube 822 to a coordinate system of a screen 826. The screen 826 may be a two-dimensional space. In an example, the screen may be a screen with a resolution of 1920×1080 pixels.

The apparatus may perform a rasterization 828 on the clipped primitive such that a series of pixels (represented by circles in the diagram 800) represent the clipped primitive. The apparatus may perform shading 830 on the rasterized, clipped primitive to add details (e.g., color, z-depth, alpha value, etc.) to the rasterized, clipped primitive. The apparatus may perform a visibility check 832 on the shaded, rasterized, clipped primitive. The visibility check 832 may result in certain pixels associated with the shaded, rasterized, clipped primitive not being displayed. After the visibility check 832, the apparatus may transmit the shaded, rasterized, clipped primitive for display on the screen 826.

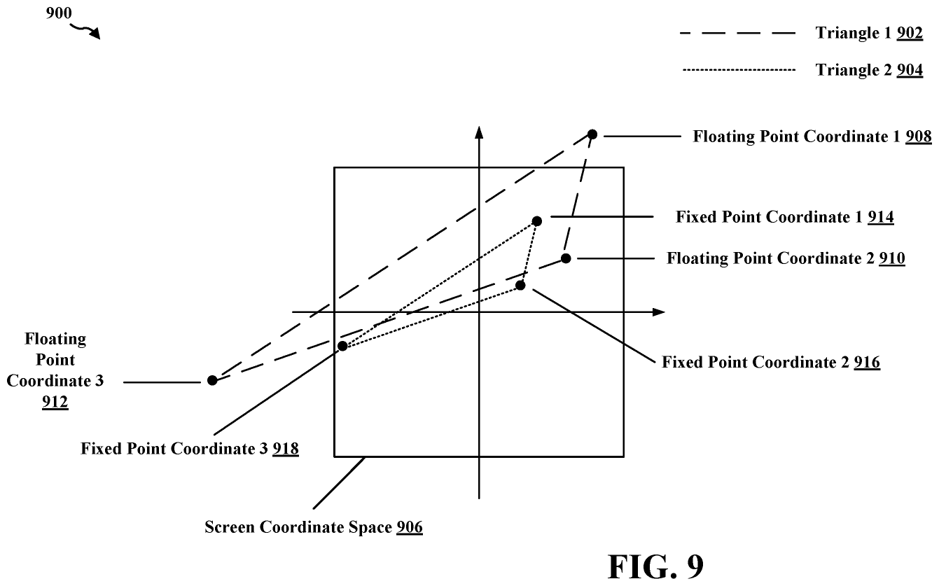

FIG. 9 is a diagram 900 illustrating an example of a first triangle 902 associated with floating point coordinates and a second triangle 904 associated with fixed point coordinates in a screen coordinate space 906. The first triangle 902 may be defined by a first floating point coordinate 908, a second floating point coordinate 910, and a third floating point coordinate 912 (collectively referred to as “the set of floating point coordinates 908-912”). In an example, the first triangle 902 may be a backface triangle. The second triangle 904 may be defined by a first fixed point coordinate 914, a second fixed point coordinate 916, and a third fixed point coordinate 918 (collectively referred to as “the set of fixed point coordinates 914-918”). The set of floating point coordinates 908-912 may be a set of homogeneous floating point coordinates. The set of fixed point coordinates 914-918 may be a set of homogenous fixed point coordinates.

An apparatus (e.g., a GPU) may obtain the set of floating point coordinates 908-912. For instance, the apparatus may obtain the set of floating point coordinates after vertex shading and a viewport transform are performed. As noted above, floating point coordinates may be associated with a greater range of data values than a range of data values associated with fixed point coordinates. As such, some or all of the set of floating point coordinates 908-912 may be outside of the screen coordinate space 906. The apparatus may scale the set of floating point coordinates 908-912 from a scale associated with a floating format to a scale associated with the screen coordinate space 906 (i.e., a scale associated with a fixed point format). Stated differently, the apparatus may scale down the first triangle 902 so that vertex coordinates after a viewport transform can be represented by fixed point screen coordinates. After scaling the set of floating point coordinates 908-912, the apparatus may convert the first floating point coordinate 908, the second floating point coordinate 910, and the third floating point coordinate 912 to the fixed point format to obtain the first fixed point coordinate 914, the second fixed point coordinate 916, and the third fixed point coordinate 918, respectively. As depicted in the diagram 900, the second triangle 904 may be a proportionally scaled down version of the first triangle 902. The first fixed point coordinate 914, the second fixed point coordinate 916, and the third fixed point coordinate 918 may be within the screen coordinate space 906.

The apparatus may identify the second triangle 904 as being a backface triangle. For instance, the apparatus may perform a triangle facing calculation on the set of fixed point coordinates 914-918 and the apparatus may identify the second triangle 904 as being a backface triangle based on results of the triangle facing calculation. In one example, the triangle facing calculation may be based on a dot product of a surface normal of the set of fixed point coordinates 914-918 and a camera-to-triangle vector being greater than or equal to zero. In another example, the triangle facing calculation may be based on a winding (clockwise or counterclockwise) of the second triangle 904.

The apparatus may cull the second triangle 904 based on the second triangle 904 being identified as a backface triangle. For instance, the apparatus may remove the second triangle 904 from a rendering process such that the second triangle 904 is not drawn or rendered on a display. The apparatus may cull the second triangle 904 without performing guard band clipping on the second triangle 904. After culling the second triangle 904, the apparatus may perform clipping on other triangles (not depicted in FIG. 9) associated with graphical content that is to be displayed in the screen coordinate space 906 (i.e., frontface triangles). The apparatus may transmit an indication of the second triangle 904, where the second triangle 904 is culled.

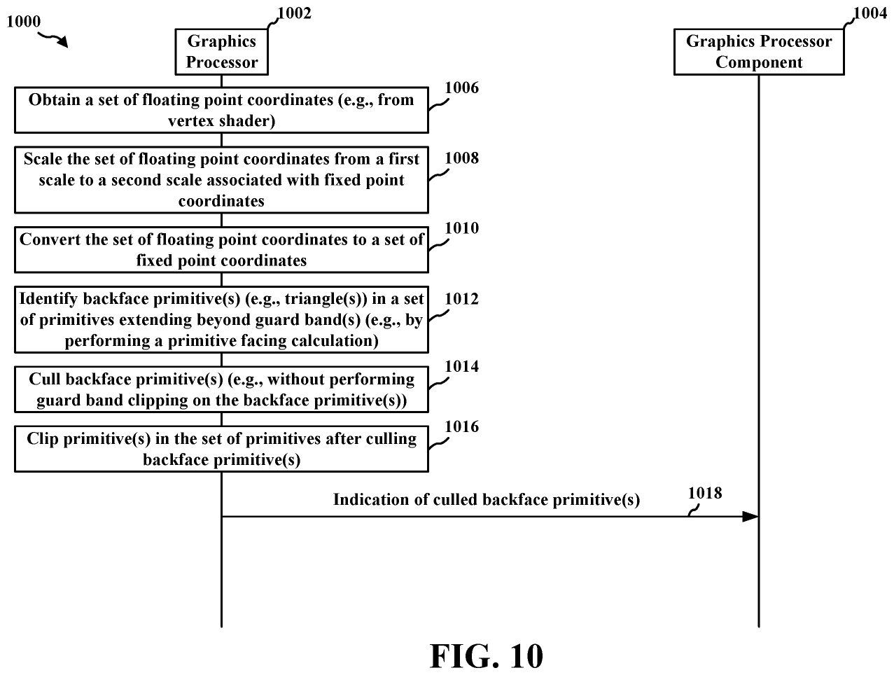

FIG. 10 is a call flow diagram 1000 illustrating example communications between a graphics processor 1002 and a graphics processor component 1004 in accordance with one or more techniques of this disclosure. In an example, the graphics processor 1002 and the graphics processor component 1004 may be included in the device 104. In an example, the graphics processor 1002 and the graphics processor component 1004 may be or include the GPU 200. In an example, the graphics processor component 1004 may be a component that performs rasterization.

At 1006, the graphics processor 1002 may obtain a set of floating point coordinates. The set of floating point coordinates may be associated with graphical content. In an example, the graphics processor 1002 may obtain the set of floating point coordinates from a vertex shader. At 1008, the graphics processor 1002 may scale the set of floating point coordinates from a first scale to a second scale. The first scale may be associated with floating point coordinates and the second scale may be associated with fixed point coordinates. At 1010, the graphics processor 1002 may convert the set of floating point coordinates to a set of fixed point coordinates.

At 1012, the graphics processor 1002 may identify backface primitive(s) in a set of primitives, where the backface primitive(s) may extend beyond guard band(s). In an example, identifying the backface primitive(s) may include performing a primitive facing calculation on the set of fixed point coordinates and identifying the back face primitive(s) based on results of the primitive facing calculation. At 1014, the graphics processor 1002 may cull the backface primitive(s) subsequent to identifying the backface primitive(s). At 1016, the graphics processor 1002 may clip primitive(s) in the set of primitives after culling the backface primitive(s). At 1018, the graphics processor 1002 may transmit an indication of the culled backface primitive(s) to the graphics processor component 1004.

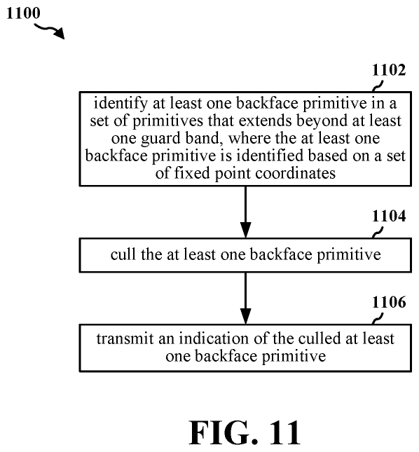

FIG. 11 is a flowchart 1100 of an example method of graphics processing in accordance with one or more techniques of this disclosure. The method may be performed by an apparatus, such as an apparatus for graphics processing, a graphics processor, a GPU, a CPU, a wireless communication device, and the like, as used in connection with the aspects of FIGS. 1-10. The method may be associated with various advantages at the apparatus, such as reduced primitive clipping which may lead to lower computational costs and lower power consumption. In an example, the method may be performed by the backface culler 198.

At 1102, the apparatus identifies at least one backface primitive in a set of primitives that extends beyond at least one guard band, where the at least one backface primitive is identified based on a set of fixed point coordinates. For example, FIG. 10 at 1012 shows that the graphics processor 1002 may identify backface primitive(s) in a set of primitives, where the backface primitive(s) may extend beyond guard band(s). In an example, the set of primitives may include primitives on the first frontface 408 and primitives on the first backface 410 of the first example 402. In another example, the set of primitives may include primitives on the second frontface 414 and primitives on the second backface 416 of the second example 412. In an example, the at least one backface primitive may be on the first backface 410 of the object 406 in the first example 402 or the second backface 416 of the object 406 in the second example 412. In an example, the at least one guard band may be or include the guard band 504. In another example, the at least one backface primitive may include the first triangle 506 and/or the second triangle 508. In yet another example, the set of fixed point coordinates may include the fixed point number 702. In a further example, the set of fixed point coordinates may include the first fixed point coordinate 914, the second fixed point coordinate 916, and the third fixed point coordinate 918. In an example, 1102 may be performed by the backface culler 198.

At 1104, the apparatus culls the at least one backface primitive. For example, FIG. 10 at 1014 shows that the graphics processor 1002 may cull the backface primitive(s) identified at 1012. Culling may include removing the at least one backface primitive from the set of primitives. In an example, 1104 may be performed by the backface culler 198.

At 1106, the apparatus transmits an indication of the culled at least one backface primitive. For example, FIG. 10 at 1018 shows that the graphics processor 1002 may transmit an indication of culled backface primitive(s) to the graphics processor component 1004. In an example, 1106 may be performed by the backface culler 198.

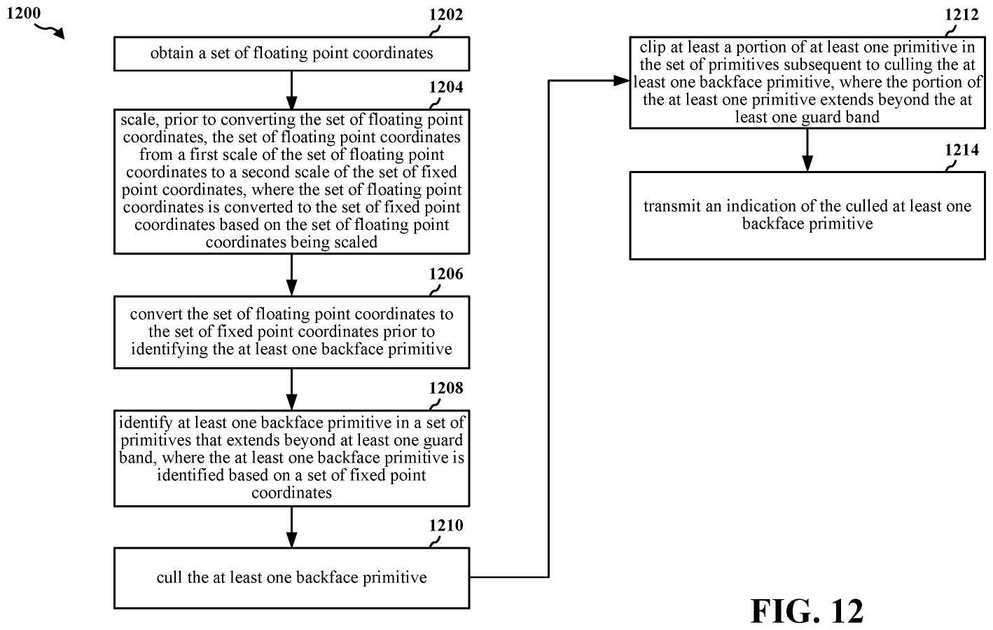

FIG. 12 is a flowchart 1200 of an example method of graphics processing in accordance with one or more techniques of this disclosure. The method may be performed by an apparatus, such as an apparatus for graphics processing, a graphics processor, a GPU, a CPU, a wireless communication device, and the like, as used in connection with the aspects of FIGS. 1-10. The method may be associated with various advantages at the apparatus, such as reduced primitive clipping which may lead to lower computational costs and lower power consumption. In an example, the method (including the various aspects detailed below) may be performed by the backface culler 198.

At 1208, the apparatus identifies at least one backface primitive in a set of primitives that extends beyond at least one guard band, where the at least one backface primitive is identified based on a set of fixed point coordinates. For example, FIG. 10 at 1012 shows that the graphics processor 1002 may identify backface primitive(s) in a set of primitives, where the backface primitive(s) may extend beyond guard band(s). In an example, the set of primitives may include primitives on the first frontface 408 and primitives on the first backface 410 of the first example 402. In another example, the set of primitives may include primitives on the second frontface 414 and primitives on the second backface 416 of the second example 412. In an example, the at least one backface primitive may be on the first backface 410 of the object 406 in the first example 402 or the second backface 416 of the object 406 in the second example 412. In an example, the at least one guard band may be or include the guard band 504. In another example, the at least one backface primitive may include the first triangle 506 and/or the second triangle 508. In yet another example, the set of fixed point coordinates may include the fixed point number 702. In a further example, the set of fixed point coordinates may include the first fixed point coordinate 914, the second fixed point coordinate 916, and the third fixed point coordinate 918. In an example, 1208 may be performed by the backface culler 198.

At 1210, the apparatus culls the at least one backface primitive. For example, FIG. 10 at 1014 shows that the graphics processor 1002 may cull the backface primitive(s) identified at 1012. Culling may include removing the at least one backface primitive from the set of primitives. In an example, 1210 may be performed by the backface culler 198.

At 1214, the apparatus transmits an indication of the culled at least one backface primitive. For example, FIG. 10 at 1018 shows that the graphics processor 1002 may transmit an indication of culled backface primitive(s) to the graphics processor component 1004. In an example, 1214 may be performed by the backface culler 198.

In one aspect, at 1212, the apparatus may clip at least a portion of at least one primitive in the set of primitives subsequent to the cull of the at least one backface primitive, where the portion of the at least one primitive extends beyond the at least one guard band. For example, FIG. 10 at 1016 shows that the graphics processor 1002 may clip primitive(s) in the set of primitives after culling backface primitive(s). In an example, clipping may include removing a portion of a primitive (e.g., a triangle) from a rendering process. In an example, the at least one primitive may be a primitive on the first frontface 408 of the object 406 in the first example 402 or the at least one primitive may be a primitive on the second frontface 414 of the second example 412. In an example, 1212 may be performed by the backface culler 198.

In one aspect, the at least one primitive may include at least one frontface primitive that may be different from the at least one backface primitive. In an example, the at least one primitive may be on the first frontface 408 and the at least one backface primitive may be on the first backface 410. In another example, the at least one primitive may be on the second frontface 414 and the at least one backface primitive may be on the second backface 416.

In one aspect, at 1202, the apparatus may obtain a set of floating point coordinates. For example, FIG. 10 at 1006 shows that the graphics processor 1002 may obtain a set of floating point coordinates. In an example, the set of floating point coordinates may include the floating point number 704. In another example, the set of floating point coordinates may include the first floating point coordinate 908, the second floating point coordinate 910, and the third floating point coordinate 912. In an example, 1202 may be performed by the backface culler 198.

In one aspect, at 1206, the apparatus may convert the set of floating point coordinates to the set of fixed point coordinates prior to identifying the at least one backface primitive. For example, FIG. 10 at 1010 shows that the graphics processor 1002 may convert the set of floating point coordinates to a set of fixed point coordinates prior to the graphics processor 1002 identifying the backface primitive(s) at 1012. In a further example, FIG. 9 shows that the first fixed point coordinate 914, the second fixed point coordinate 916, and the third fixed point coordinate 918 may be converted into the first floating point coordinate 908, the second floating point coordinate 910, and the third floating point coordinate 912, respectively. In another example, converting the set of floating point coordinates to the set of fixed point coordinates may include converting the floating point number 704 to the fixed point number 702. In an example, 1206 may be performed by the backface culler 198.

In one aspect, obtaining the set of floating point coordinates may include obtaining the set of floating point coordinates from a vertex shader. For example, FIG. 10 at 1006 shows that obtaining the set of floating point coordinates may include obtaining the set of floating point coordinates from a vertex shader.

In one aspect, at 1204, the apparatus may scale, prior to converting the set of floating point coordinates, the set of floating point coordinates from a first scale of the set of floating point coordinates to a second scale of the set of fixed point coordinates, where the set of floating point coordinates may be converted to the set of fixed point coordinates based on the set of floating point coordinates being scaled. For example, FIG. 10 at 1008 shows that the graphics processor 1002 may scale a set of floating point coordinates from a first scale to a second scale prior to converting the set of floating point coordinates to the set of fixed point coordinates at 1010, where the first scale may be associated with floating point coordinates and where the second scale may be associated with fixed point coordinates. In an example, the first scale may be associated with the floating point number 704 and the second scale may be associated with the fixed point number 702. In a further example, scaling the set of floating point coordinates from the first scale to the second scale may include aspects described above in connection with FIG. 9. In an example, 1204 may be performed by the backface culler 198.

In one aspect, the first scale may represent a first data range and the second scale may represent a second data range, where the first data range is greater than the second data range. In an example, the first data range may be +/−(2−2⁻²³)×2¹²⁷, which is approximately equal to +/−3.4028235×10³⁸ and the second data range may be [−32768, 32767.99609375] as described above in connection with FIG. 7.

In one aspect, the second scale may be associated with a fixed point coordinate range. In an example, the fixed point coordinate range (i.e., a screen coordinate space) may be associated with the screen coordinate space 906. In another example, a display associated with the screen coordinate space may be or include the display(s) 131.

In one aspect, the set of floating point coordinates may be associated with vertices of graphical content. For example, the first floating point coordinate 908, the second floating point coordinate 910, and the third floating point coordinate 912 may be associated with vertices of graphical content.

In one aspect, the set of floating point coordinates may include a set of homogenous floating point coordinates. For example, the set of floating point coordinates may include aspects described above with respect to FIG. 6 pertaining to homogenous space. For instance, each floating point coordinate in the set of floating point coordinates may be in XYZW format.

In one aspect, the at least one backface primitive may be culled without performing guard band clipping on the at least one backface primitive. For example, FIG. 10 at 1014 shows that the graphics processor 1002 may cull backface primitive(s) without performing guard band clipping on the backface primitive(s).

In one aspect, the at least one backface primitive may include at least one backface triangle. For example, FIG. 10 at 1012 shows that the backface primitive(s) may include triangle(s).

In one aspect, identifying the at least one backface primitive in the set of primitives may include performing a primitive facing calculation on the set of fixed point coordinates, where the at least one backface primitive may be identified based on a result of the primitive facing calculation. For example, FIG. 10 at 1012 shows that identifying the backface primitive(s) may include performing a primitive facing calculation.

In one aspect, the at least one backface primitive may not be drawn based on the at least one backface primitive being culled. For example, a backface primitive on the first backface 410 or the second backface 416 may not be drawn based on the backface primitive being culled.

In configurations, a method or an apparatus for graphics processing is provided. The apparatus may be a graphics processor, GPU, a CPU, or some other processor that may perform graphics processing. In aspects, the apparatus may be the processing unit 120 within the device 104, or may be some other hardware within the device 104 or another device. The apparatus may include means for identifying at least one backface primitive in a set of primitives that extends beyond at least one guard band, where the at least one backface primitive is identified based on a set of fixed point coordinates. The apparatus may further include means for culling the at least one backface primitive. The apparatus may further include means for transmitting an indication of the culled at least one backface primitive. The apparatus may further include means for clipping at least a portion of at least one primitive in the set of primitives subsequent to culling the at least one backface primitive, where the portion of the at least one primitive extends beyond the at least one guard band. The apparatus may further include means for obtaining a set of floating point coordinates. The means for obtaining the set of floating point coordinates may include means for obtaining the set of floating point coordinates from a vertex shader. The apparatus may further include means for scaling, prior to converting the set of floating point coordinates, the set of floating point coordinates from a first scale of the set of floating point coordinates to a second scale of the set of fixed point coordinates, where the set of floating point coordinates is converted to the set of fixed point coordinates based on the set of floating point coordinates being scaled. The means for identifying the at least one backface primitive in the set of primitives may include means for performing a primitive facing calculation on the set of fixed point coordinates, where the at least one backface primitive is identified based on a result of the primitive facing calculation.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 a method of graphics processing, including: identifying at least one backface primitive in a set of primitives that extends beyond at least one guard band, where the at least one backface primitive is identified based on a set of fixed point coordinates; culling the at least one backface primitive; and transmitting an indication of the culled at least one backface primitive.
Aspect 2 is the method of aspect 1 and further includes clipping at least one primitive in the set of primitives subsequent to culling the at least one backface primitive.
Aspect 3 is the method of aspect 2 and includes that the at least one primitive includes at least one frontface primitive that is different from the at least one backface primitive.
Aspect 4 is the method of any of aspects 1-3 and further includes obtaining a set of floating point coordinates; and converting the set of floating point coordinates to the set of fixed point coordinates prior to identifying the at least one backface primitive.
Aspect 5 is the method of aspect 4 and includes that obtaining the set of floating point coordinates includes obtaining the set of floating point coordinates from a vertex shader.
Aspect 6 is the method of any of aspects 4-5 and further includes scaling, prior to converting the set of floating point coordinates, the set of floating point coordinates from a first scale of the set of floating point coordinates to a second scale of the set of fixed point coordinates, where the set of floating point coordinates is converted to the set of fixed point coordinates based on the set of floating point coordinates being scaled.
Aspect 7 is the method of aspect 6 and includes that the first scale represents a first data range, where the second scale represents a second data range, where the first data range is greater than the second data range.
Aspect 8 is the method of any of aspects 6-7 and includes that the second scale is associated with a fixed point coordinate range.
Aspect 9 is the method of any of aspects 4-8 and includes that the set of floating point coordinates is associated with a set of vertices for graphical content.
Aspect 10 is the method of any of aspects 4-9 and includes that the set of floating point coordinates includes a set of homogenous floating point coordinates.
Aspect 11 is the method of any of aspects 1-10 and includes that the at least one backface primitive is culled without performing guard band clipping on the at least one backface primitive.
Aspect 12 is the method of any of aspects 1-11 and includes that the at least one backface primitive includes at least one backface triangle, where culling the at least one backface primitive includes removing the at least one backface triangle from the set of primitives.
Aspect 13 is the method of any of aspects 1-12 and includes that identifying the at least one backface primitive in the set of primitives includes: performing a primitive facing calculation on the set of fixed point coordinates, where the at least one backface primitive is identified based on a result of the primitive facing calculation.
Aspect 14 is the method of any of aspects 1-13 and includes that the at least one backface primitive is not drawn or rendered based on the at least one backface primitive being culled.
Aspect 15 is an apparatus for graphics processing including at least one processor coupled to a memory and configured to implement a method as in any of aspects 1-14.
Aspect 16 may be combined with aspect 15 and includes that the apparatus is a wireless communication device, further including at least one of a transceiver or an antenna coupled to the at least one processor, where the at least one processor is configured to transmit the indication of the culled at least one backface primitive via at least one of the transceiver or the antenna.
Aspect 17 is an apparatus for graphics processing including means for implementing a method as in any of aspects 1-14.
Aspect 18 is a computer-readable medium (e.g., a non-transitory computer-readable medium) storing computer executable code, the computer executable code when executed by at least one processor causes the at least one processor to implement a method as in any of aspects 1-14.

Various aspects have been described herein. These and other aspects are within the scope of the following claims.

What is claimed is:

1. An apparatus for graphics processing, comprising:
a memory; and
at least one processor coupled to the memory and, based at least in part on information stored in the memory, the at least one processor is configured to:
identify at least one backface primitive in a set of primitives that extends beyond at least one guard band, wherein the at least one backface primitive is identified based on a set of fixed point coordinates;
cull the at least one backface primitive; and
transmit an indication of the culled at least one backface primitive.

2. The apparatus of claim 1, wherein the at least one processor is further configured to:
clip at least a portion of at least one primitive in the set of primitives subsequent to the cull of the at least one backface primitive, wherein the portion of the at least one primitive extends beyond the at least one guard band.

3. The apparatus of claim 2, wherein the at least one primitive comprises at least one frontface primitive that is different from the at least one backface primitive.

4. The apparatus of claim 1, wherein the at least one processor is further configured to:
obtain a set of floating point coordinates; and
convert the set of floating point coordinates to the set of fixed point coordinates prior to the at least one processor being configured to identify the at least one backface primitive.

5. The apparatus of claim 4, wherein to obtain the set of floating point coordinates, the at least one processor is configured to obtain the set of floating point coordinates from a vertex shader.

6. The apparatus of claim 4, wherein the at least one processor is further configured to:
scale, prior to the at least one processor being configured to convert the set of floating point coordinates, the set of floating point coordinates from a first scale of the set of floating point coordinates to a second scale of the set of fixed point coordinates, wherein to convert the set of floating point coordinates, the at least one processor is configured to convert the set of floating point coordinates to the set of fixed point coordinates based on the set of floating point coordinates being scaled.

7. The apparatus of claim 6, wherein the first scale represents a first data range, wherein the second scale represents a second data range, wherein the first data range is greater than the second data range.

8. The apparatus of claim 6, wherein the second scale is associated with a fixed point coordinate range.

9. The apparatus of claim 4, wherein the set of floating point coordinates is associated with a set of vertices for graphical content.

10. The apparatus of claim 4, wherein the set of floating point coordinates comprises a set of homogenous floating point coordinates.

11. The apparatus of claim 1, wherein to cull the at least one backface primitive, the at least one processor is configured to cull the at least one backface primitive without being configured to perform guard band clipping on the at least one backface primitive.

12. The apparatus of claim 1, wherein the at least one backface primitive comprises at least one backface triangle, wherein to cull the at least one backface primitive, the at least one processor is configured to remove the at least one backface triangle from the set of primitives.

13. The apparatus of claim 1, wherein to identify the at least one backface primitive in the set of primitives, the at least one processor is configured to:
perform a primitive facing calculation on the set of fixed point coordinates, wherein to identify the at least one backface primitive, the at least one processor is configured to identify the at least one backface primitive based on a result of the primitive facing calculation.

14. The apparatus of claim 1, wherein the at least one backface primitive is not drawn or rendered based on the at least one processor being configured to cull the at least one backface primitive.

15. The apparatus of claim 1 wherein the apparatus is a wireless communication device, further comprising at least one of a transceiver or an antenna coupled to the at least one processor, wherein the at least one processor is configured to transmit the indication of the culled at least one backface primitive via at least one of the transceiver or the antenna.

16. A method of graphics processing, comprising:
identifying at least one backface primitive in a set of primitives that extends beyond at least one guard band, wherein the at least one backface primitive is identified based on a set of fixed point coordinates;
culling the at least one backface primitive; and
transmitting an indication of the culled at least one backface primitive.

17. The method of claim 16, further comprising:
clipping at least a portion of at least one primitive in the set of primitives subsequent to culling the at least one backface primitive, wherein the portion of the at least one primitive extends beyond the at least one guard band.

18. The method of claim 17, wherein the at least one primitive comprises at least one frontface primitive that is different from the at least one backface primitive.

19. The method of claim 16, further comprising:
obtaining a set of floating point coordinates; and
converting the set of floating point coordinates to the set of fixed point coordinates prior to identifying the at least one backface primitive.

20. The method of claim 19, wherein obtaining the set of floating point coordinates comprises obtaining the set of floating point coordinates from a vertex shader.

21. The method of claim 19, further comprising:
scaling, prior to converting the set of floating point coordinates, the set of floating point coordinates from a first scale of the set of floating point coordinates to a second scale of the set of fixed point coordinates, wherein the set of floating point coordinates is converted to the set of fixed point coordinates based on the set of floating point coordinates being scaled.

22. The method of claim 21, wherein the first scale represents a first data range, wherein the second scale represents a second data range, wherein the first data range is greater than the second data range.

23. The method of claim 21, wherein the second scale is associated with a fixed point coordinate range.

24. The method of claim 19, wherein the set of floating point coordinates is associated with a set of vertices for graphical content.

25. The method of claim 19, wherein the set of floating point coordinates comprises homogenous floating point coordinates.

26. The method of claim 16, wherein the at least one backface primitive is culled without performing guard band clipping on the at least one backface primitive.

27. The method of claim 16, wherein the at least one backface primitive comprises at least one backface triangle, wherein culling the at least one backface primitive comprises removing the at least one backface triangle from the set of primitives.

28. The method of claim 16, wherein identifying the at least one backface primitive in the set of primitives comprises:
performing a primitive facing calculation on the set of fixed point coordinates, wherein the at least one backface primitive is identified based on a result of the primitive facing calculation.

29. The method of claim 16, wherein the at least one backface primitive is not drawn or rendered based on the at least one backface primitive being culled.

30. A computer-readable medium storing computer executable code, the computer executable code, when executed by at least one processor, causes the at least one processor to:
identify at least one backface primitive in a set of primitives that extends beyond at least one guard band, where the at least one backface primitive is identified based on a set of fixed point coordinates;
cull the at least one backface primitive; and
transmit an indication of the culled at least one backface primitive.
